(19) United States
(12) Patent Application Publication
(10) Pub. No.: US 2002/0050365 A1
(43) Pub. Date: May 2, 2002

(54) Electric hand-held tool with percussion mechanism

(76) Inventors: Hans-Werner Bongers-Ambrosius, Munich (DE); Peter Gerold, Weilheim (DE)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 09/891,043

(22) Filed: Jun. 25, 2001

(30) Foreign Application Priority Data
Jun. 24, 2000 (DE) 100 30 962.3

(51) Int. Cl. B25D 11/00

(52) U.S. Cl. 173/128

(57) ABSTRACT

An electrical hand held tool including a percussion mechanism (2) with a striker (3) having a striking region (6), a chuck (4) for receiving a working tool (7); and an annular channel (8) provided in the striking region (6) of the striker (3); and having at least one side opening (9) communicating with the underpressure-producing ventilation system (5) of the electromotor of the hand-held tool.

### BACKGROUND OF INVENTION

1. Field of the Invention

The present invention relates to percussion, electric hand-held tool having a percussion mechanism, such as hammer drill, chisel hammer, or combination hammer, preferably, for removing stone material.

2. Description of the Prior Art

In electric hand-held tools with a percussion mechanism, e.g. in an electropneumatic tool, an impact, which is produced by a driving piston, is transmitted by a striker to an end surface of a working tool which is supported in the chuck of the hand-held tool with a possibility of a limited axial displacement.

During working a stone or similar material, the produced dust spreads over the surfaces of the hand-held tool and can reach, to some extent, the operational region of the striker, bypassing the sealing means provided in the hand-held tool to prevent penetration of the dust. The dust can accumulate in the striking region of the striker and then penetrate further into the percussion mechanism and the drive of the hand-held tool The penetration of the dust into the drive significantly increases the wear of gear tooth flanks of the drive gears. The noticeably high wear of the movable components of the hand-held tool significantly reduces the service life of the hand-held tool.

French Patent No. 806,543 discloses a pneumatic hammer in which a free space, which is provided in the hammer chuck and which defines the striking region of a striker, communicates via a radial opening with atmosphere. With the striker located in the free space in the chuck, an annular channel is formed around the striker. The hammer drive provides for delivery into the annular space, through a bypass and an annual flush channel, of compressed air. The compressed air, together with the accumulated dust, escapes through the radial opening into the atmosphere. The foregoing method of dust removal is not suitable for electric tool as the compressed air is not available in these tools.

U.S. Pat. No. 4,553,610 discloses a percussion hydraulic tool in which an annual channel is provided in the region in which the working tool is received. A bypass and a check valve connects the annular channel with the space in which the striking piston is displaced. The compressed air, which is produced upon the impact displacement of the striking piston, flows through the check valve and the bypass channel into the annular channel and, therefrom, together with the accumulated dust, escapes along the outer surface of the working tool into the atmosphere. The stream of the compressed air, together with the dust, flows, during the working displacement of the working tool, in a direction opposite to the direction of air flow, with the dust, into the percussion tool. This is a rather complicated solution.

European Publication EPO 346 597 also discloses a hydraulically operated hand-held tool the driving piston of which defines a pump space in which compressed air is produced during reciprocating displacement of the driving piston. Through a bypass channel, the compressed air flows into an annular space that surrounds the striker and the working tool received in the chuck of the hand-held tool. From the annular space, the compressed air, together with the dust accumulated in the annular space, escapes along the outer surface of the working tool into the atmosphere.

The drawback of this solution consists in that the compressed air, together with dust particles, also penetrates inside the hand-held tool along the surface of the striker due to presence of a compressed air in the annular space.

An object of the present invention is to provide simple and reliable means that would prevent penetration of the dust into the percussion mechanism and the drive of the electric hand-held tool.

### SUMMARY OF THE INVENTION

This and other objects of the present invention, which will become apparent hereinafter, are achieved by providing, in an electrical hand-held tool including a percussion mechanism with a striker, a chuck for receiving a working tool, an annular channel in the striking region of the striker and which communicates with the ventilation system for the electomotor of the hand-held tool through one or several radial openings, so that the dust is aspirated from the annular channel when the underpressure is generated by the ventilation system.

With the dust being aspirated from the annular channel, the penetration of the dust in the percussion mechanism and the drive is reliably prevented.

Advantageously, the dust is aspirated by the ventilation system through a bypass so that the electromotor is not cooled by a dust-containing air.

The novel features of the present invention, which are considered as characteristics for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a cross-section view of electrical hand-held tool according to the present invention; and

FIG. 2 a detail of the hand-held tool shown in FIG. 1.

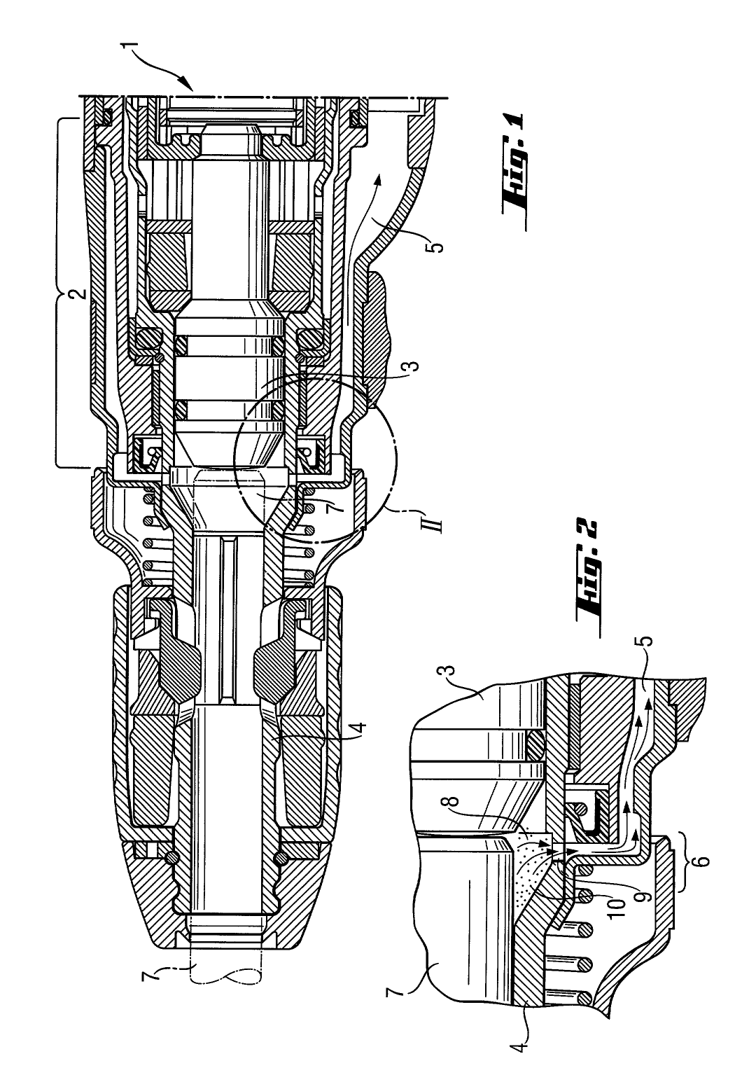

### DETAILED DESCRIPTION OF THE PREFERRED EMBODIMENT

An electric hand-held tool 1 according to the present invention which is shown in the drawings, includes a percussion mechanism 2 with a striker 3, a chuck 4, and a ventilation system 5 having a section that bypasses the tool electric motor (not shown).

As shown in FIG. 2, at the end side of a working tool 7 which is received in the chuck 4, in the impact region 6 of the striker 3, there is provided an annular channel 8 connected with underpressure-producing ventilation system 5 by at least one opening 9. Dust 10, which would penetrate along the outer surface of the working tool 7, and which could accumulate in the striking region 6, would be removed through the opening(s) 9 by the underpressure-vacuum-producing ventilation system 5.

Though the present invention was shown and described with references to the preferred embodiment, such are merely illustrative of the present invention and are not to be construed as a limitation thereof, and various modifications of the present invention will be apparent to those skilled in the art. It is, therefore, not intended that the present invention be limited to the disclosed embodiments or details thereof, and the present invention includes all variations and/or alternative embodiment within the spirit and scope of the present invention as defined by the appended claims.

What is claimed is:

1. An electrical hand-held tool, comprising a percussion mechanism (2) including a striker (3) having a striking region (6); a chuck (4) for receiving a working tool (7); an annular channel (8) provided in the striking region (6) of the striker (3) at a location corresponding to an innermost position of rear end surface of the working tool received in the chuck, and an underpressure-producing ventilation system (5) for an electromotor of the hand-held tool, the annular channel (8) having at least one side opening (9) communicating with the ventilation system (5).

2. An electric hand-held tool according to claim 1, wherein the ventilation system (5) comprises an electromotor bypassing channel, and wherein the at least one opening (9) opens into the bypassing channel.
